(19) United States
(12) Patent Application Publication
(10) Pub. No.: US 2015/0081583 A1
(43) Pub. Date: Mar. 19, 2015

(54) CONFIRMING DELIVERY LOCATION USING RADIO FINGERPRINTING

(71) Applicant: Amazon Technologies, Inc., Reno, NV (US)

(72) Inventors: David George Butler, San Jose, CA (US); John Christopher O'Hare, Seattle, WA (US); Sreekar Ramachandra Tanuku, Seattle, WA (US); Arvind Thiagarajan, Cambridge, MA (US)

(73) Assignee: Amazon Technologies, Inc., Reno, NV (US)

(21) Appl. No.: 14/030,450

(22) Filed: Sep. 18, 2013

(51) Int. Cl. G06Q 10/08

(52) U.S. Cl. CPC G06Q 10/0833
USPC 705/333

(57) ABSTRACT

A system and method for confirming a delivery location. A delivery agent equipped with a device, for example, a mobile device, delivers a package to a location. When the package is delivered, the delivery agent triggers a delivery-event on the device, and in response to the delivery-event the device determines an RF fingerprint at the location. The RF fingerprint is stored, and a comparison of the RF fingerprint to previously stored RF fingerprints correlated to particular locations is performed. If the RF fingerprint determined by the first device corresponds to a previously stored RF fingerprint at the correct delivery location, the current delivery location is confirmed as correct.

### BACKGROUND

With the advancement of technology, the use and popularity of electronic devices, such as computers and smart phones, has increased considerably. People are often interested in searching and purchasing merchandise from a store or provider via the internet, which is then shipped to the purchaser. Confirming that a package has been delivered to the correct location is important to ensuring good customer experiences and reducing fraud. Traditionally to confirm that a package was delivered to the correct location the delivery personnel would request a signature from the purchaser or other person at the delivery location. However obtaining this signature can be time consuming and is susceptible to fraud.

### BRIEF DESCRIPTION OF DRAWINGS

For a more complete understanding of the present disclosure, reference is now made to the following description taken in conjunction with the accompanying drawings.

FIG. 1 illustrates a system overview for implementing aspects of the disclosure.

FIG. 2 is a block diagram conceptually illustrating a computing device according to aspects of the present disclosure.

FIG. 3 illustrates a computing network for use with distributed processing according to aspects of the present disclosure.

FIG. 4 illustrates a distributed environment according to aspects of the present disclosure.

FIG. 5 is a flow diagram illustrating an exemplary method for confirming a delivery location based on radio frequency (RF) fingerprinting according to aspects of the present disclosure.

FIG. 6 is an exemplary database structure of RF fingerprints according to aspects of the present disclosure.

FIG. 7 is a flow diagram illustrating an exemplary method for confirming delivery location according to aspects of the present disclosure.

FIG. 8 is a flow diagram illustrating an exemplary method for identifying a delivery location according to aspects of the present disclosure.

FIG. 9 is a flow diagram illustrating an exemplary method for implementing aspects of the present disclosure.

FIG. 10 is a flow diagram illustrating an exemplary method for implementing aspects of the present disclosure.

### DETAILED DESCRIPTION

Aspects of the present disclosure include devices, systems and methods for confirming a location of delivery using radio frequency fingerprinting techniques. In one aspect, a radio frequency (RF) fingerprint, for example, based on wireless signal strengths at the delivery location, which are generally quickly obtainable and unique to within a few meters of the location. This RF fingerprint can then be cross-checked against a database of locations and corresponding RF fingerprints to confirm that the location is the correct location for the delivery.

An RF fingerprint is a representation of wireless signals that is detectable by a device. The RF fingerprint may include the identity of certain detectable wireless signals, such as signals associated with certain WiFi networks and/or specific transmitters or access points, cellular signals, Bluetooth signals, other wireless transmissions, or ambient RF noise, etc. The RF fingerprint may include associated signal strengths, operating frequencies, network identification codes, pilot signals, etc. for detected RF signals. RF fingerprints may change with changes in location, for example as certain wireless signals become undetectable (or lose strength) and others become detectable (or gain strength). Thus an RF fingerprint taken by a device at a specific location may serve as an identifier of the device's location or proximity to certain wireless transmitters. If an RF fingerprint is taken at a particular location, an RF fingerprint taken by a device at a later time may be matched to the earlier RF fingerprint to determine if the device has returned to the particular location (or close enough to the particular location).

In an aspect, confirmation or verification of the delivery location involves a delivery agent that is equipped with a device, such as a computing device, a laptop computer, a cellular phone, a personal digital assistant (PDA), a tablet computer, other mobile devices, etc. This device includes a wireless signal receiving component, such as a WiFi chip, that regularly scans (for example, every few seconds or more) for visible wireless access points (for example, basic service set identifiers (BSSIDs)) and their associated radio frequency (RF) signal strengths. These wireless access points and their associated RF signal strengths create a fingerprint (radio frequency fingerprint) based on location.

When a delivery is made, a delivery-event is triggered on the device, which can include scanning an identifier of a parcel (such as a UPC code, QR code, etc.), clicking a button requesting location confirmation, or other action by the delivery agent. In response to the delivery-event the RF fingerprint at the location is collected and logged, which is similar to the collection and logging of a delivery recipient's signature. The RF fingerprint is particular to a given location within a few meters, and may be difficult to estimate without being present at that location. While the RF fingerprint of a location can change over time (for example as wireless access points are added and removed from service) there is generally stability over time since a number of the wireless access points will likely remain even if one or a few are taken out of service. Thus, comparing a new RF fingerprint to one or more existing RF fingerprints may assist in location determination.

Using an RF fingerprint for confirming delivery location is advantageous because, among other reasons, the RF fingerprint at the location will likely show a strong RF signal to the recipient's own access point. A range to the wireless access point may also be estimated and logged. For example, the distance from the front door where the package was placed to the wireless access point is about 7-10 meters based on RF signal strength. This could be made more accurate by cross referencing the manufacture of the wireless base station by base-station ID for default RF transmission power and configuration information. Further, subsequent deliveries to any given location or address may have a higher assurance of correctness based on the RF fingerprint. The second, third, ninth, etc., time a package is delivered to address ‘X’, each RF fingerprint sample is compared against one or more previous RF fingerprints taken at the same location. The correlation between the RF fingerprints will be similar if the physical location is the same. This aids not only the detection of fraud on claims of undelivered packages, but also can be used to correct delivery agent error(s) in real-time as the package is delivered (i.e., notifying the delivery agent if an attempted delivery location is potentially incorrect) saving time and customer frustration.

As deliveries are repeated, a log of the RF fingerprints along routes of the delivery agent may be built to detect deviation from the route and provide data for efficiency analysis. Dead-reckoning based on delivery-agent step data (i.e., estimating the delivery agent's position over time based the delivery agent's known position based on the RF fingerprints) and compass heading may also be collected. This information trail of RF fingerprints and step-data plus compass bearing may be used to provide a map of the most efficient route to each previously visited address. Based on accuracy and available data, the route could provide sufficient data for automated delivery mechanisms, for example, robotic delivery methods. In the more immediate term, new drivers/delivery agents would have the advantage of knowing the route to the destination address that previous delivery agents took. These data may be combined with other information, such as latitude/longitude information obtain from a satellite location system, such as global positioning systems (GPS), or other system, to form robust maps, routes, and/or location determining totals.

Collecting the RF fingerprint at the point of delivery of each package provides real-time validation of correct location, evidence for fraud detection and prevention, and data for increasing the efficiency of delivery agents. GPS alone can be slow, power-inefficient, known without necessarily noting the location and hence of little value in proving confirmation to the customer that a delivery agent was present. However, a RF fingerprint can actually be shown to the customer on an application on the customer's device to prove delivery. Being able to confirm that deliveries to the same address are in fact at the same location in real-time is advantageous especially in subscription delivery models. New drivers or drivers unfamiliar with a route can have real-time confirmation that the package was delivered to the same position as a previous delivery in real-time.

The following description provides exemplary implementations of the disclosure. Persons having ordinary skill in the field of computers, audio, and mapping technology will recognize components and process steps described herein that may be interchangeable with other components or steps, or combinations of components or steps, and still achieve the benefits and advantages of the present disclosure. Moreover, in the following description, numerous specific details are set forth in order to provide a thorough understanding of the disclosure. It will be apparent to one skilled in the art, however, that the disclosure may be practiced without some or all of these specific details. In other instances, well-known process steps have not been described in detail in order not to unnecessarily obscure the disclosure.

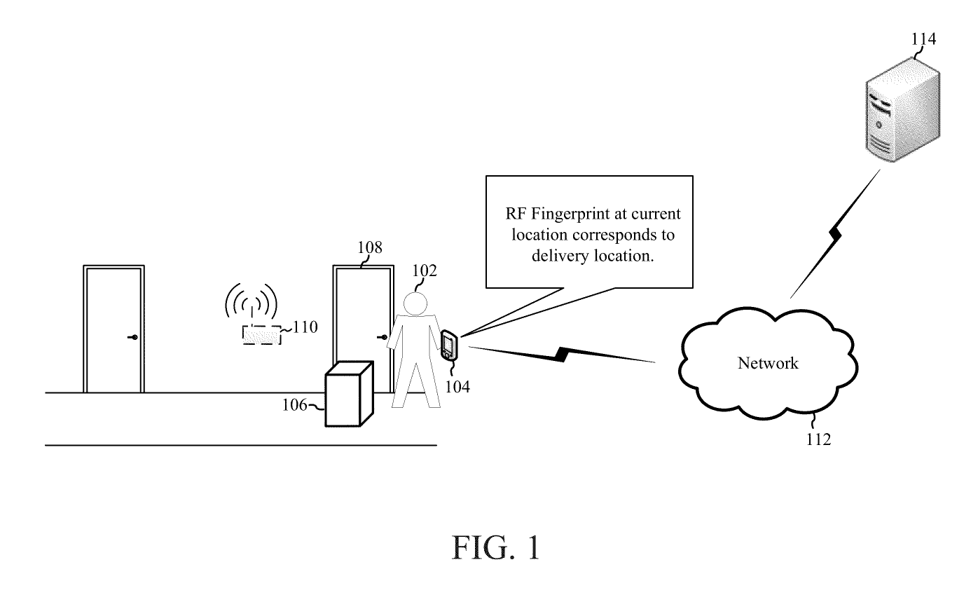

FIG. 1 illustrates a system overview according to an aspect of the disclosure. As illustrated, a delivery agent 102 equipped with a first device 104, such as a computing device, a laptop computer, a cellular phone, a personal digital assistant (PDA), a tablet computer, other mobile devices, etc., delivers a package 106 to a location, for example, a residence 108. The first device 104 includes a wireless signal receiving component, such as a WiFi chip, that regularly scans (for example, every few seconds or more) for visible wireless access points (for example, BSSIDs) and their associated radio frequency (RF) signal strengths. In this example, the residence includes a wireless access point 110, and there may be additional wireless access points in the area, for example, in neighboring residences or other establishments that the first device 104 can detect. These wireless access points and their associated RF signal strengths are detected by the first device 104, as the device 104 goes from location to location.

When the package 106 is delivered, the delivery agent 102 triggers a delivery-event on the first device 104, which can include scanning the package 106, activating a button or other action. In response to the delivery-event the first device 104 determines an RF fingerprint at the location. The RF fingerprint includes information about wireless signals detected at the location of the first device 104 at the time of the delivery-event. The RF fingerprint may include network identifiers along with corresponding signal strengths, ambient radio noise, and/or other information. The first device 104 may then transmit the RF fingerprint, optionally along with package delivery information, over a network 112 to a second device 114. The second device 114 receives the RF fingerprint, stores the RF fingerprint, and performs a comparison of the RF fingerprint to previously stored RF fingerprints correlated to particular locations. If the RF fingerprint determined by the first device 104 corresponds to a previously stored RF fingerprint at the correct delivery location, the second device 114 informs the first device 104 that the current delivery location is correct. In this manner, the delivery agent 102 is informed that the package 106 is being delivered to the correct location. On the other hand, if the RF fingerprint determined by the first device 104 does not correspond to a previously stored RF fingerprint at the correct delivery location, the delivery agent 102 may be notified that the package may be delivered to an incorrect location and the delivery agent 102 can then re-check whether the package is indeed supposed to be delivered to the current location or if the delivery agent 102 is at the wrong location.

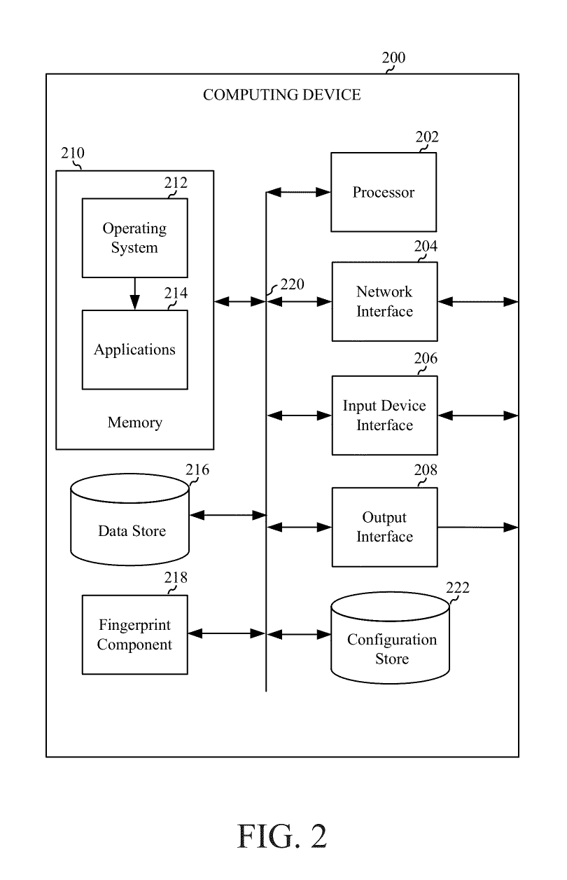

Aspects of the present disclosure may be implemented as a computer implemented method in a computing device or computer system. These computing devices may include, but are not limited to, mobile phones, laptop computers, tablet computers, personal computers, workstations, mini- and mainframe computers, servers, and the like. These computing devices may also include specially configured computers for processing digital multi-media content. The general architecture of a suitable computing device is described below with reference to FIG. 2. More particularly, FIG. 2 is a block diagram illustrating exemplary components of a computing device 200 suitable for confirming delivery location using RF fingerprinting. However, the following description of the exemplary components of a computing device 200 should be viewed as illustrative only and not construed as limiting in any manner. In one aspect, the first device 104 or the second device 114 shown in FIG. 1 may be implemented as the exemplary computing device 200, for example.

With regard to FIG. 2, the exemplary computing device 200 may include a processor 202 in communication with a variety of other components over a system bus 220 or through a direct connection. These other components may include, by way of example, a network interface 204, an input device interface 206, an output interface 208, and a memory 210. As appreciated by those skilled in the art, the network interface 204 enables the computing device 200 to communicate data, control messages, data requests, and other information with other resources including computers, data sources, storage devices, and the like, on a computer network such as the Internet. The network interface 204 may be configured to communicate via wired or wireless connections. As one skilled in the art will appreciate, the computing device 200 may obtain scan and identify wireless access points via the computer network or other network. The computing device 200 may also determine and send RF fingerprints to a networked location, such as another computer on the network, for example.

The input device interface 206, sometimes also embodied as an input/output interface, enables the computing device 200 to obtain data input from a variety of devices including, but not limited to, a microphone, a digital pen, a touch screen, a keyboard, a mouse, a scanner, and the like. In addition to the exemplary components described above, an output interface 208 may be used for outputting information such as audio signals or display information. Display information may be output by the output interface 208 via a display device (e.g., a monitor or similar device, not shown), for example. Audio output may also be output by the output interface 208 to an audio device such as a speaker, for example. Of course, while not shown, one skilled in the art will appreciate that one or more speakers, may be incorporated as an integral element within a computing device 200 or may be separate therefrom.

The processor 202 may be configured to operate in accordance with programming instructions stored in a memory 210. The memory 210 generally comprises RAM, ROM, and/or other memory. Thus, in addition to storage in read/write memory (RAM), programming instructions may also be embodied in read-only format, such as those found in ROM or other permanent memory. The memory 210 may store an operating system 212 for controlling the operation of the computing device 200. The operating system may be a general purpose operating system such as a Microsoft Windows operating system, a UNIX operating system, a Linux operating system, or an operating system specifically written for and tailored to the computing device 200. Similarly, the memory 210 may also store user-executable applications 214, or programs, for conducting various functions on the computing device 200. For example, the application 214 in memory 210 may be configured according to aspects of the present disclosure to determine and compare RF fingerprints to confirm delivery locations.

The computing device 200 may also include a data store 216 and an RF fingerprint component 218. The data store 216 may store location data associated with network availability and signal strength information (RF fingerprints) associated with locations that may be used to confirm delivery location according to aspects of the present disclosure. The RF fingerprint component 218 may be configured to determine the RF fingerprint at a particular location. The determination may be made in response to a delivery-event, may be made continuously, or may be made under other conditions. The RF fingerprint component may receive wireless signal information from various other components of the computing device 200 including network interface 204, input device interface 206 and/or other components (such as a WiFi chip, cellular chip, or other wireless communication device) which may be incorporated into the network interface and/or input device interface 206.

It should also be understood that the following description is presented largely in terms of logic and operations that may be performed by conventional computer components and media components. These computer components, may be grouped in a single location or distributed over a wide area. In circumstances where the computer components are distributed, the components may be accessible to each other via wired and/or wireless communication links, for example.

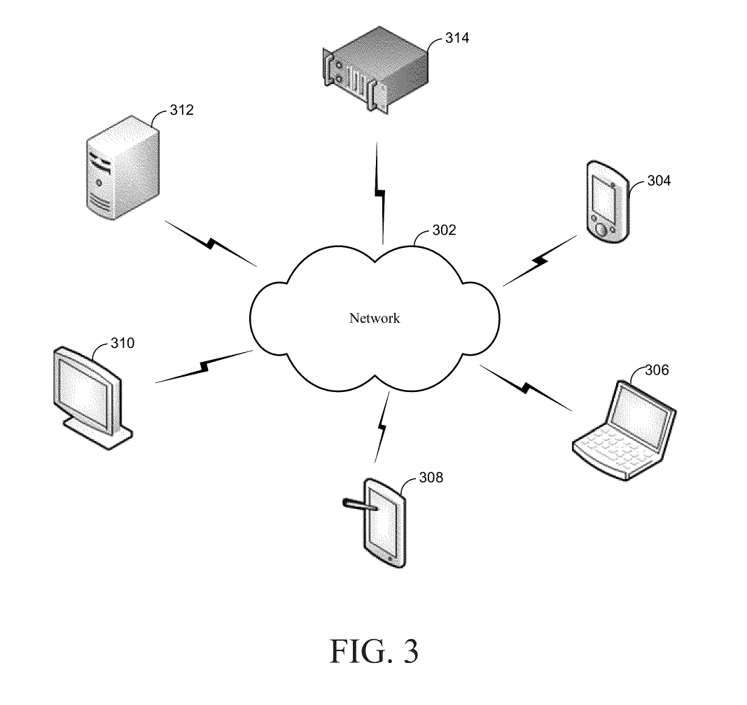

As shown in FIG. 3, multiple devices may be connected over a network 302. Network 302 may include a local or private network or may include a wide network such as the internet. Devices may be connected to the network 302 through either wired or wireless connections. For example, a wireless device 304 may be connected to the network 302 through a wireless service provider. Other devices, such as laptop 306 or tablet computer 308 may be capable of connection to the network 302 using various connection methods including through a wireless service provider, over a WiFi connection, or the like. Other devices, such as computer 310, may connect to the network 302 through a wired connection.

In certain system configurations, one or more remote devices may receive a determined RF fingerprints from a remote device, store the RF fingerprints, correlate the RF fingerprints to locations, and compare fingerprints determined by local devices to stored RF fingerprints to confirm delivery location. For example, a RF fingerprint determined by a local wireless device 304 may be sent over the network 302 to wireless device 304 by computer 312 or server 314 or the same device that determines the RF fingerprint may perform the correlations to confirm the delivery location.

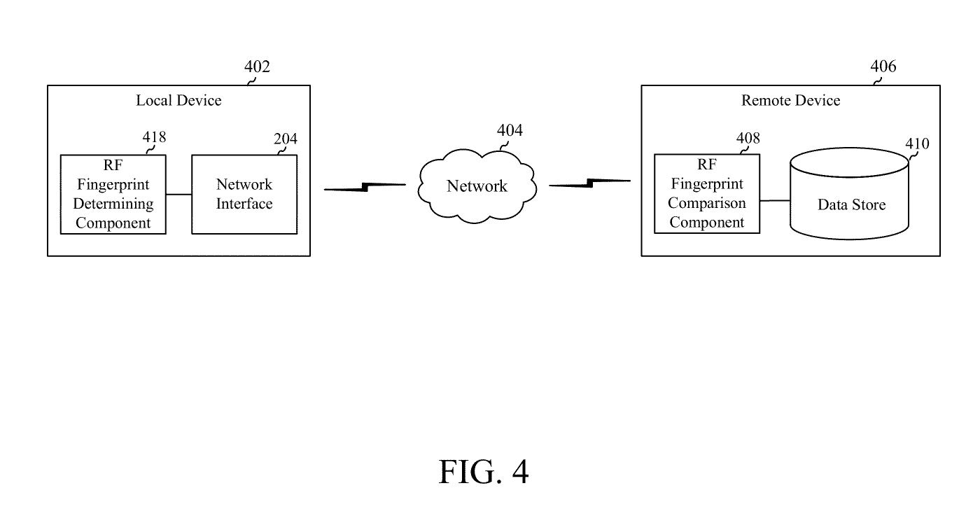

One configuration of the present disclosure is shown in FIG. 4. In this configuration, a local device 402 may include an RF fingerprint determining component 418 and the network interface 204. The local device 402 may determine and transmit an RF fingerprint over a network 404 to a remote device 406. The network 406 may be a wide area network such as the Internet, a local area network, a network allowing physical connection of the devices, a wireless communication network, or other suitable connection between the devices including a direct (wired or wireless) connection. In one aspect, the RF fingerprint may be sent to the remote device as part of an inventory control message, thus allowing the delivery agent device to confirm delivery location and delivery with the inventory control system in a single message. For example, if a delivery agent scans a package with a wireless device, the wireless device may send the package information along with the RF fingerprint in a single message to the remote device to both track the package and confirm the delivery location using the RF fingerprint. The remote device 406 may include an RF fingerprint comparison component 408 and a data store 410. The RF fingerprint determining component 418 and/or RF fingerprint comparison component 408 may be incorporated into the RF component 218 discussed in reference to FIG. 2. The data store 410 may include a database of previously stored RF fingerprints correlated with locations, such as addresses and recipients. The RF fingerprint comparison component 408 may compare a recently stored RF fingerprint to the database of RF fingerprints to confirm delivery location of a current delivery, and transmit confirmation to the local device 402. If the delivery location is correct, the remote device 406 may send a message to the local device 402 indicating the correct location. The message may also include information about inventory control, such as confirming that delivery has been recorded in the inventory control system. In another aspect the remote device 406 may also include an RF fingerprint determining component, however the RF fingerprint determining component of the remote device 406 may determine the RF fingerprint by receiving a message of an RF fingerprint from a local device.

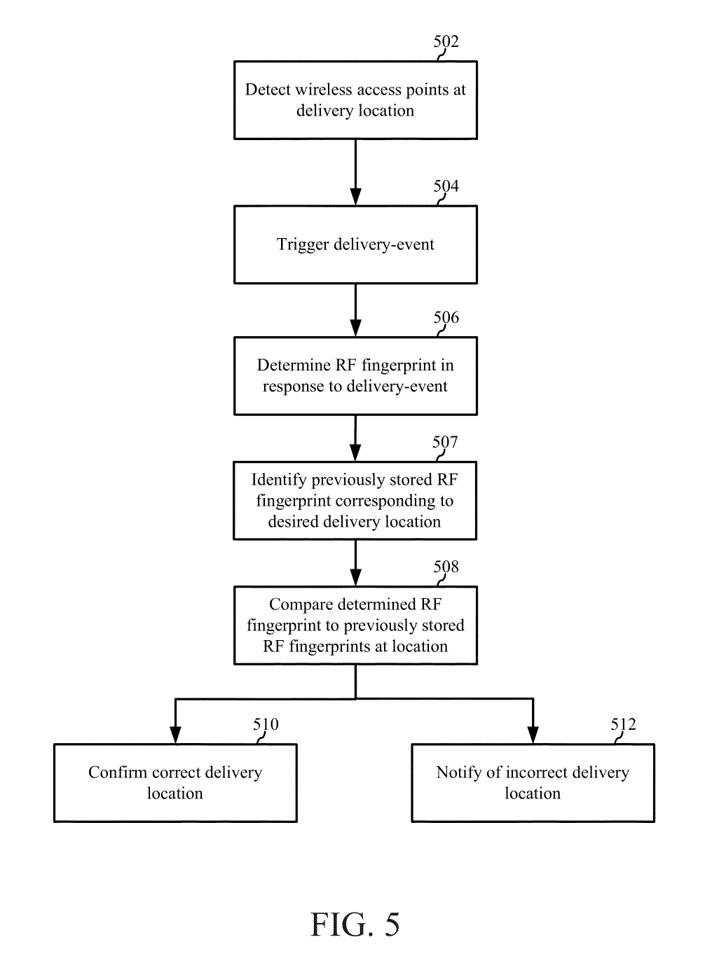

The systems and methods disclosed herein allow for confirmation of delivery locations using RF fingerprinting. FIG. 5 is a flow diagram illustrating an exemplary method for confirming a delivery location based on RF fingerprinting. As an example, one or more of the logical components of FIGS. 1-4 may perform the methods disclosed herein. In block 502, one or more wireless network access points, for example, transmitting radio frequency (RF), WiFi SSIDs, or other wireless transmissions, are detected by a mobile device of a delivery agent at a potential delivery location. At the delivery location a delivery-event is triggered, illustrated as block 504. In response to the delivery-event the mobile device (for example using the RF fingerprint determining component 418) determines an RF fingerprint at the delivery location, illustrated as block 506. As described above, the radio fingerprint may be information corresponding to available network(s) and their associated signal strength(s). In one example, at least one available network may be a wireless network (SSID) and associated signal strength of the network corresponding to the address of the delivery location. In another example, the RF fingerprint may comprise an array indicating detected wireless signals and characteristics corresponding to those wireless signals. Example forms of RF fingerprints are shown as follows, though other configurations of RF fingerprints may be used:

RF Fingerprint 1:

[Detected signal A: transmitting station ID, strength, frequency

Detected signal B: transmitting station ID, strength, frequency

Detected signal C: transmitting station ID, strength, frequency]

RF Fingerprint 2:

[Detected signal A: network name, transmitting station ID, strength

Detected signal B: network name, transmitting station ID, strength

Detected signal C: network name, transmitting station ID, strength]

RF Fingerprint 3:

[Detected signal A: transmitting station ID, strength, technology type (e.g., WiFi)

Detected signal B: transmitting station ID, strength, technology type

Detected signal C: transmitting station ID, strength, technology type]

When the RF fingerprint of the delivery location is determined, the system may identify a previously stored RF fingerprint(s) corresponding to the desired delivery location, identified as block 507. The previously stored RF fingerprint(s) corresponding to the desired delivery location may be identified by comparing desired delivery address information to a database of stored RF fingerprints and delivery addresses. The proper previously stored RF fingerprint(s) may be identified by identifying the stored RF fingerprint corresponding to the desired delivery address. The determined RF fingerprint is then compared to compared to the previously stored RF fingerprint(s) correlated to the current delivery location, illustrated as block 508. This may be done, for example, by the RF fingerprint comparison component 408. When the determined RF fingerprint matches or corresponds to the previously stored RF fingerprint(s) based on a probability model, the delivery location is confirmed as correct, illustrated as block 510. In an example, a package is being delivered to an address for which a previously stored RF fingerprint at that same delivery address has been determined on a previous delivery. The previously stored RF fingerprint(s) is compared to the currently determined RF fingerprint to confirm that deliveries to the same address are actually being delivered to the same location.

When the currently determined RF fingerprint does not match or correspond to the previously stored RF fingerprint(s), the delivery location can be identified as incorrect, illustrated as block 512. When the delivery confirmation indicates an incorrect delivery location, the delivery agent can re-check the address of the delivery location, and/or move to another location and repeat the method of FIG. 5 to confirm the subsequent delivery location(s) is correct.

Comparison of a detected RF fingerprint to a previously recorded RF fingerprint may be done in a number of ways. In one, the arrays corresponding to the detected RF fingerprint and previously recorded RF fingerprint may be plotted in a multi-dimensional space, with each dimension representing characteristics of detected wireless networks. Data points corresponding to detected characteristics of a wireless network (such as signal strength, operating frequency, etc.) may be plotted and compared to each other. Based on the distance between the RF fingerprints in the multi-dimensional space, a probability may be assigned indicating a likelihood that the RF fingerprints correspond to the same location. This may be referred to as a probability model. For example, one factor for consideration may be the number of wireless signals detected in both the detected RF fingerprint and the previously recorded RF fingerprint. Another factor may be the comparative signal strength of the respective overlapping wireless signals. These factors (and/or others) may be plotted for the different detected wireless signal access points across both RF fingerprints under consideration. The distance between the factors, cumulatively or individually, may be considered to be a measurement of the similarity of the compared RF fingerprints. A probability score may be assigned to the compared pair based on the distance. If the score is above a certain threshold, the RF fingerprints may be considered to be substantially similar to each other.

The probabilities may be assigned to different distances based on various testing and environmental conditions when configuring the system. The probability may also be a function of a combination of parameters. For example, a first parameter may be a number of matching wireless signal access points that appear on each compared RF fingerprint. A second parameter may be how far the plotted signal strength of a wireless signal access point is for one fingerprint as compared to the same access point for the other fingerprint. A third parameter may be the existence of a wireless signal access point in one RF fingerprint but not the other. Depending on how the parameters compare across the RF fingerprints, a score may be assigned to the comparison indicating a probability that the RF fingerprints correspond to the same location. In another example, certain parameters may be weighted differently when comparing RF fingerprints or corresponding parameters. For example, if a wireless signal access point appears in a recent RF fingerprint but does not appear in an older RF fingerprint, that parameter may be weighted differently (for example, not considered as important) than if a wireless signal access point appeared in an older RF fingerprint but not in a more recent one. The probability score of a comparison of the RF fingerprints may be adjusted accordingly pursuant to the weights for various comparison considerations. Comparison considerations may be organized in a weighted hierarchy where comparisons at the top of the hierarchy are given a higher weight than those at the bottom.

In an aspect, when the RF fingerprint partially matches a previously recorded RF fingerprint, that is to say, when it includes, for example, 3 out of 4 networks that are associated with a location, this may indicate that someone moved or a network was changed, etc. In this situation, the system may instruct the delivery person to go to another newer location (e.g., two apartments down) and take another RF fingerprint reading for comparison purposes. If the initial RF fingerprint (at the delivery location) and second RF fingerprint (at the 2nd check location) both have a correlation with expected readings above a certain threshold, the system may determine that delivery location is correct. Or, alternatively, the system may simply perform a threshold detection on the original delivery location. If there is a high enough RF fingerprint correlation (for example, greater than 70%) the delivery location may be confirmed.

In an aspect, RF fingerprints from deliveries that received no customer complaints may be used to create a database of RF fingerprints correlated to delivery addresses. Thus, when a delivery agent delivers a package to a delivery location, the delivery address and a current RF fingerprint can be compared to the database and confirmation of the delivery location can be provided to the delivery agent.

RF fingerprints may also be correlated to other data, for example, geographic positioning data, such as GPS data, barometric pressure, recipient name, and other location type data. Data such as barometric pressure may be collected by the device of the delivery agent at the point of delivery. As is commonly known GPS data may not be an accurate measure of location indoors, such as in office buildings and apartment complexes. However, RF fingerprints can be used alone or in combination with other data to confirm delivery location in a 3-D (x, y, z) coordinate system to ensure a delivery is being made, for example, to a correct apartment in an apartment complex.

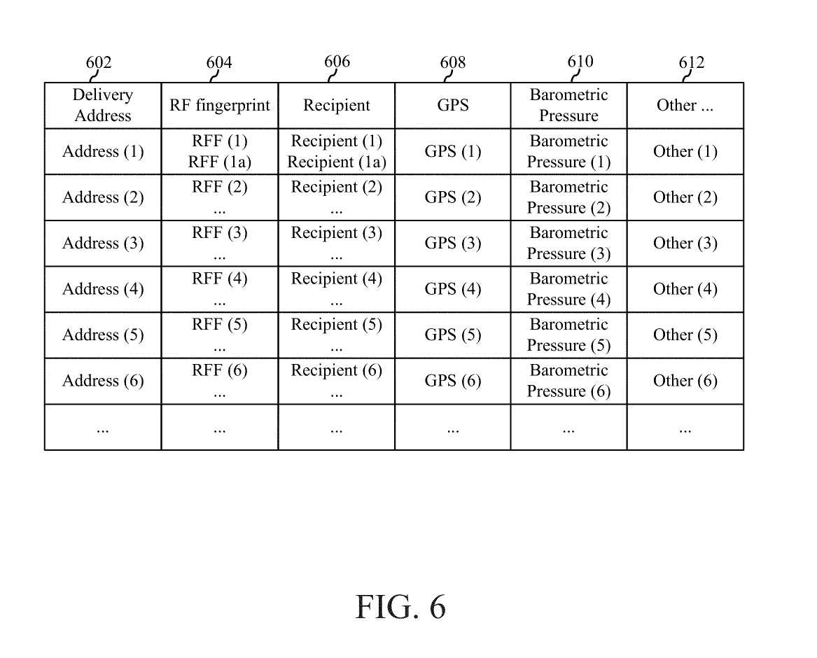

FIG. 6 is an exemplary database structure of RF fingerprints according to an aspect of the disclosure. As illustrated in FIG. 6, the database may be structured to correlate a delivery address 602 with an RF fingerprint 604. Thus, when a delivery agent transmits an RF fingerprint, optionally along with delivery address information, the correct delivery address may be used to look-up a previous RF fingerprint of the delivery address and identify, for example, using a probability model, whether the determined RF fingerprint corresponds to the delivery address.

Additional data may also be correlated with the RF fingerprint 604 and delivery address 602, for example, recipient name 606, GPS data 608, barometric pressure 610, and other data 612. This additional data may also be collected by the device of the delivery agent in response to the delivery-event. Using more data may allow for a more accurate and granular level of delivery location confirmation.

Also, it should be appreciated that numerous RF fingerprints 604, recipient names 606, GPS data 608, barometric pressure 610, and other location type data 612 can be associated with a single delivery address 602. For example, more than one person may be living or working at a certain address, thus, there may be multiple names that packages may be addressed to at the same address. Additionally, barometric pressure data may be useful in determining altitude, for example, aiding in identifying a floor in a multi-level building.

The recipient name 606 may also be used in conjunction with the RF fingerprint to identify when a person moves addresses. When a person moves addresses, it is possible that the RF fingerprint will change as well since the new person at that address may have a new wireless access point or router that will be put in service. Thus, when the RF fingerprint changes along with the recipient name, the system may know that such an RF fingerprint change was likely to occur and account for the change when comparing previous RF fingerprints for that location to confirm delivery location.

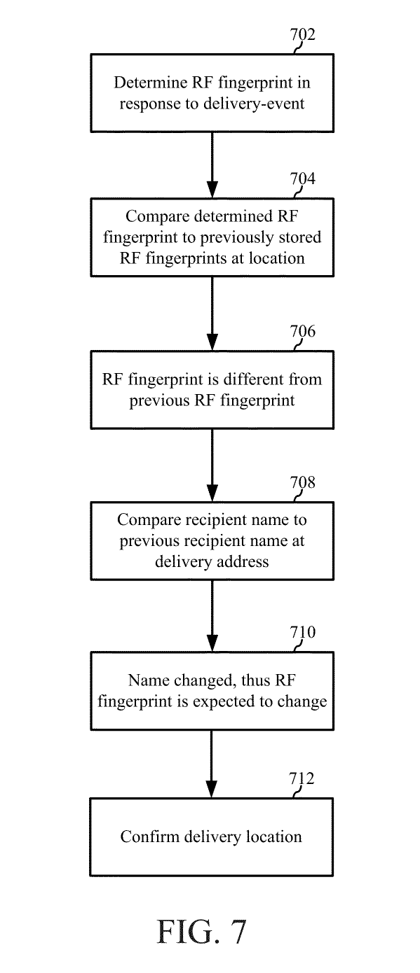

FIG. 7 is a flow diagram illustrating an exemplary method for confirming delivery location when a recipient name changes. As described above, one or more wireless network access points, for example, transmitting radio frequency (RF), WiFi SSIDs, or other wireless transmissions, are detected by a mobile device of a delivery agent at a potential delivery location. At the delivery location a delivery-event is triggered. In response to the delivery-event the mobile device of the delivery agent determines an RF fingerprint at the delivery location, illustrated as block 702. The determined RF fingerprint is compared to previously stored RF fingerprints correlated to the delivery address, illustrated as block 704. In this example, the determined RF fingerprint is different that the previously stored RF fingerprint, illustrated as block 706.

The recipient name at the delivery address is compared to the previously stored recipient name at the same address, illustrated as block 708. The name is identified to have changed, and thus the system understands that the RF fingerprint may change by a certain amount, illustrated as block 710. If the RF fingerprint is close to the previous RF fingerprint within a certain probability, the delivery location may be confirmed, illustrated as block 712.

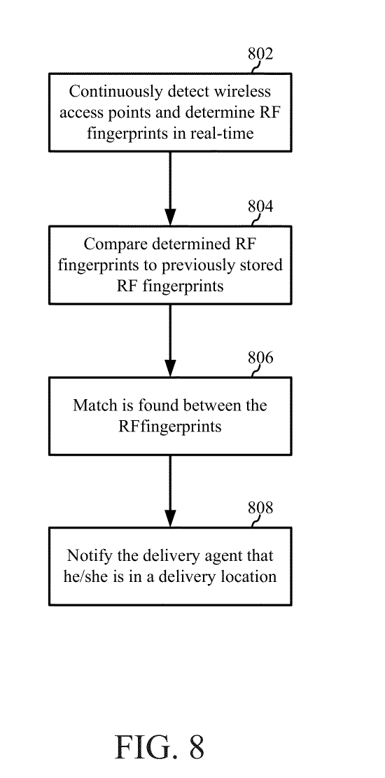

In an aspect, the device of the delivery agent may collect RF fingerprint data and optionally additional data in real-time along the route of the delivery agent. This data may be used to notify a delivery agent that the delivery agent is in a location for a delivery, rather than the delivery agent confirming delivery location. FIG. 8 is a flow diagram illustrating an exemplary method for identifying a delivery location. In block 802, a device of the delivery agent continuously detects wireless access points and determines RF fingerprints in real-time along a route of the delivery agent. The determined RF fingerprints are compared to previously stored RF fingerprints in a database in real-time, illustrated as block 804. A match of the determined RF fingerprint, based on a probability model, to a previously stored RF fingerprint is found, illustrated as block 806, and the delivery agent is notified that the delivery agent is in a delivery location, illustrated as block 808. This allows the delivery agent to make the delivery, since the delivery agent is in the delivery location, even if the delivery is not the next scheduled delivery. This can also aid a delivery agent in finding a correct delivery location if the delivery agent is having difficulty finding the delivery location using other means. In another aspect the system may use RF fingerprint information to notify a delivery agent when he/she is approaching a delivery location. When the delivery agent's device determines an RF fingerprint that corresponds to a location within a certain distance to the desired delivery location, the system may notify the agent that the delivery location is nearby and, if determined, the direction and distance of the delivery location. For example, if a delivery agent is instructed to deliver a package to a central mail room of an office, the system may direct the agent to the central mail room based on the known RF fingerprint of the mail room and the RF fingerprint(s) detected by the agent's device as the agent navigates the office environment.

Continuous determination of RF fingerprints may also be used to track and plan routes for delivery agents to increase efficiency. As described above, additional data may also be correlated to or mapped to RF fingerprints to increase accuracy and provide a more granular location based mapping.

In an aspect, the recipient may also be invited to provide the RF fingerprint of his/her delivery address. This information can be used to confirm delivery location. Potential recipients may provide RF fingerprints detected by their own individual devices through a customized device application provided to recipients, through a web interface, or through other methods. A potential recipient may determine multiple RF fingerprints that correspond to multiple potential delivery locations (for example, front door, back door, conference room, mail room, etc.). Those RF fingerprints may then be associated by the system with their respective potential delivery locations and other information such as physical address, latitude/longitude information, barometric pressure, etc. The associated information may be provided by a potential recipient or determined by the system using known information or information determined from other sources.

The potential recipient may also indicate which wireless signals are associated with the recipient, such as the SSID or other identity of a wireless access point (i.e., WiFi access point) under the control of the recipient. The expected signal strength of that access point may be strong at the delivery address associated by the user. Thus, in an aspect, the probability of confirmation may be increased at a delivery location when a wireless access point associated with the recipient is detected, further increasing confidence of confirming the correct delivery location.

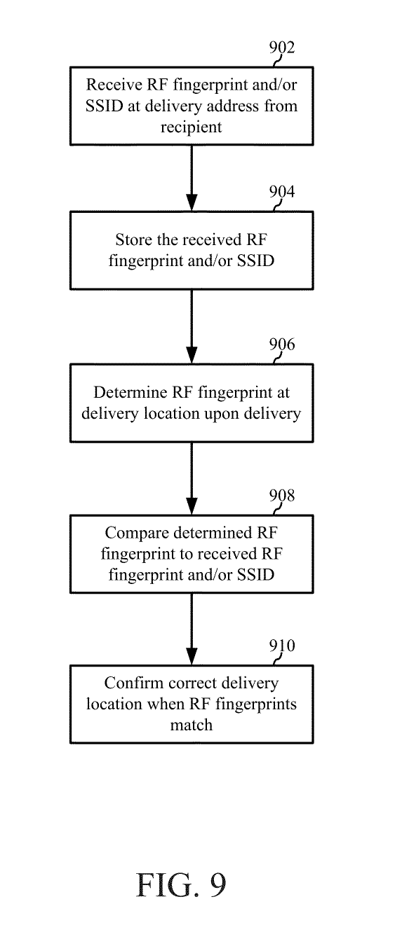

FIG. 9 illustrates an exemplary implementation of the method described above. In block 902, a RF fingerprint and/or SSID at the delivery location is received from a recipient at the delivery location. This may occur in advance of a delivery attempt. The received RF and/or SSID fingerprint is correlated or mapped to the delivery address and stored, illustrated as block 904. At the time of delivery, the device of the delivery agent determines the RF fingerprints at the delivery location, illustrated as block 906. The determined RF fingerprint is compared to the previously received RF fingerprint and/or SSID in a database, illustrated as block 908. The delivery location is confirmed as the delivery address when the determined RF fingerprint and the previously received RF fingerprint and/or SSID match, based on a probability model, illustrated as block 910.

In another aspect, the RF fingerprint may be provided to a recipient for independent verification by the recipient and/or used to provide a location of a package delivery to the recipient. For example, the signal strength(s) of the RF fingerprint may be used to provide a distance measurement from a wireless access point (wireless router) of the recipient, such as about 10 feet from the wireless access point, or provide a map to the location of the package. This information may be sent to the recipient, for example, via electronic mail, text messaging, voice mail, etc. The recipient may also be able to access an account associated with the delivery to obtain such information. Such information may aid a recipient in finding a location of where the package was physically delivered.

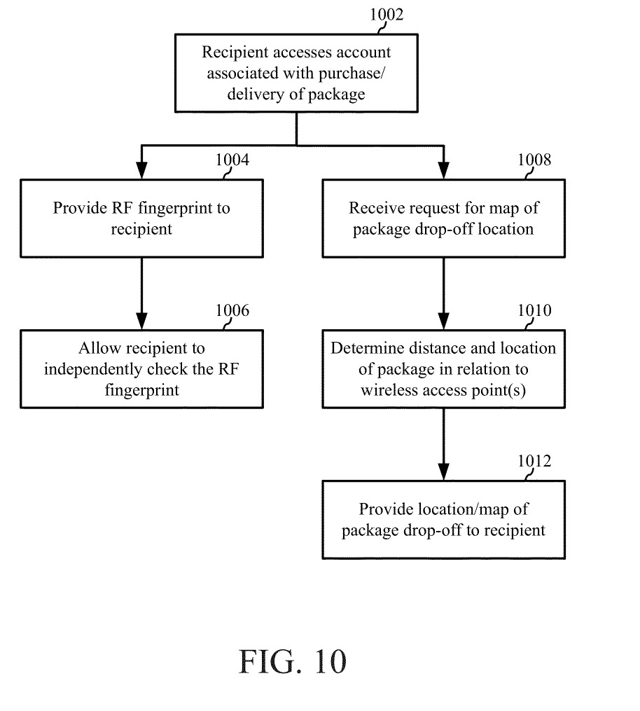

FIG. 10 illustrates an exemplary implementation of the method described above. In block 1002, a recipient accesses an account associated with the recipient's purchase or delivery of the recipient's package. An RF fingerprint determined upon delivery is provided to the recipient, illustrated as block 1004. The recipient is then able to independently verify the RF fingerprint to confirm that the delivery agent did in fact deliver to the correct address, for example, by determining an RF fingerprint and comparing it to the RF fingerprint determined by the delivery agent, illustrated as block 1006.

In an aspect, the recipient can request a map of where the package was actually dropped off. The system receives the request, illustrated as block 1008, and determines a map/location of where the package was dropped-off in relation to the strongest wireless access point, for example, based on the signal strengths of the detected wireless access points, illustrated as block 1010. The map/location may then be provided to the recipient, illustrated as block 1012. The recipient can then use the map/location to find the package. The system may generate a route from a user defined location, such as a particular office in a building, to the delivery location, such as a particular mail room. The route may be generated based on RF fingerprints detected during the delivery process (or at another time) and stored with the system. The route may then be generated in response to a user query for the package location.

In one aspect, if the system receives confirmation that the package was delivered correctly, the RF fingerprint that was determined during the package delivery may be added to the system as another potential comparison fingerprint for the delivery address. Thus the determined RF fingerprint may be stored by the system until such time as a user or other entity confirms the package was delivered correctly. Upon receipt of confirmation the stored RF fingerprint may be associated with the target delivery address and stored with other RF fingerprints corresponding to the target delivery address.

As discussed above, the RF fingerprint is based on wireless routers, for example, WiFi routers. However, the RF fingerprint may be based on other technologies or a combination of technologies, for example, WiFi, cellular towers, Bluetooth detection, radio bands, etc. For example, a full frequency spectrum scan or specific frequencies may be used. In one embodiment, a frequency scan in the range of 2.4 GHz and 5 GHz is used. In other embodiments, a frequency scan in the range of cellular towers is used. In yet other embodiments, a full or partial frequency scan in any number of ranges can be used.

As discussed above, the various embodiments may be implemented in a wide variety of operating environments, which in some cases can include one or more user computers, computing devices, or processing devices which can be used to operate any of a number of applications. Local and remote devices can include any of a number of general purpose personal computers, such as desktop or laptop computers running a standard operating system, as well as cellular, wireless, and handheld devices running mobile software and capable of supporting a number of networking and protocols. Such a system also may include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of communication, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java, C, C# or C++, or any scripting language, such as Perl, Python, or TCL, as well as combinations thereof. The server(s) may also include database servers, including without limitation those commercially available from Oracle, Microsoft, Sybase, and IBM.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad, or microphone), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the system or device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A method for confirming a desired delivery location of an item, comprising:
collecting, at a first time, first information about one or more wireless signals detected at a first location, the first information including one or more of a signal identifier, a signal strength, or a signal frequency of the one or more wireless signals;
identifying second information about one or more wireless signals detected at a second time at a desired delivery location, wherein the second time is previous to the first time;
determining a number of overlapping wireless signals, wherein an overlapping wireless signal is a wireless signal that is included in both the first information and second information;
determining a detected signal strength in the first information and second information for each overlapping wireless signal;
determining a score representing a probability that the first location is the same as the desired delivery location, wherein the score is determined using the number of overlapping wireless signals and the corresponding determined signal strengths in the first information and second information; and
confirming that the first location is the same as the desired delivery location in response to the score being above a threshold.

2. The method of claim 1, wherein collecting the first information is performed in response to a delivery-event, wherein the delivery-event comprises processing an inventory identifier of the item prior to delivery, and wherein the method further comprises sending the inventory identifier and first information from a device at the first location to a remote device.

3. The method of claim 1, further comprising:
identifying a number of wireless signals represented in the second information that are not represented in the first information; and
reducing the score, wherein an amount of the reducing is determined by the number of wireless signals represented in the second information that are not represented in the first information.

4. The method of claim 1, further comprising:
receiving an indication that the item was delivered correctly;
associating the first information with the desired delivery location; and
storing the first information for use in confirming a delivery location for a future delivery attempt.

5. A method comprising:
determining a radio frequency fingerprint at a delivery location; and
comparing the determined radio frequency fingerprint with a previously stored radio frequency fingerprint.

6. The method of claim 5, wherein the radio frequency fingerprint comprises one or more of a wireless signal identifier, a wireless signal strength, a wireless signal frequency, an identifier of a wireless signal transmitter, or content of a pilot signal of a wireless signal.

7. The method of claim 5, further comprising transmitting a message to a local device in response to the determined radio frequency fingerprint being substantially similar to the previously stored radio frequency fingerprint, wherein the message includes an indication that the delivery location is correct.

8. The method of claim 5, wherein the previously stored radio frequency fingerprint is associated with one or more of an address, an individual's name, latitude/longitude data, or barometric pressure data.

9. The method of claim 5, wherein the comparing of the determined radio frequency fingerprint with the previously stored radio frequency fingerprint comprises:
comparing a number of wireless signals and corresponding signal strength of the determined radio frequency fingerprint with a number of wireless signals and corresponding signal strength of the previously stored radio frequency fingerprint; and
determining a score based on a result of the comparing.

10. The method of claim 5, further comprising:
providing an interface to a user device to record a radio frequency fingerprint at a potential delivery location;
receiving a recorded radio frequency fingerprint from the user device;
associating the recorded radio frequency fingerprint with the potential delivery location; and
storing the recorded radio frequency fingerprint and associated potential delivery location.

11. The method of claim 5, further comprising, in response to a request for notification of the delivery location, sending a user an indication of the delivery location based at least in part on the radio frequency fingerprint.

12. The method of claim 5, further comprising:
receiving a plurality of radio frequency fingerprints from a local device; and
sending a notification to the local device indicating that the local device is in a location for a delivery in response to at least one of the plurality of radio frequency fingerprints being substantially similar to a previously stored radio frequency fingerprint associated with a target delivery location for the delivery.

13. A system for confirming a delivery location, comprising:
at least one processor; and
a memory device including instructions operable to be executed by the at least one processor to perform a set of actions, configuring the processor:
to determine a radio frequency fingerprint at a delivery location; and
to compare the determined radio frequency fingerprint with a previously stored radio frequency fingerprint.

14. The system of claim 13, wherein the radio frequency fingerprint comprises one or more of a wireless signal identifier, a wireless signal strength, a wireless signal frequency, an identifier of a wireless signal transmitter, or content of a pilot signal of a wireless signal.

15. The system of claim 13, wherein the at least one processor is further configured to transmit a message to a local device in response to the determined radio frequency fingerprint being substantially similar to the previously stored radio frequency fingerprint, wherein the message includes an indication that the delivery location is correct.

16. The system of claim 13, wherein the previously stored radio frequency fingerprint is associated with one or more of an address, an individual's name, latitude/longitude data, or barometric pressure data.

17. The system of claim 13, wherein the at least one processor configured to compare the determined radio frequency fingerprint with the previously stored radio frequency fingerprint comprises the at least one processor configured to:
compare a number of wireless signals and corresponding signal strength of the determined radio frequency fingerprint with a number of wireless signals and corresponding signal strength of the previously stored radio frequency fingerprint; and
determine a score based on a result of the comparing.

18. The system of claim 13, wherein the at least one processor is further configured:
to provide an interface to a user device to record a radio frequency fingerprint at a potential delivery location;
to receive a recorded radio frequency fingerprint from the user device;
to associate the recorded radio frequency fingerprint with the potential delivery location; and
to store the recorded radio frequency fingerprint and associated potential delivery location.

19. The system of claim 13, wherein the at least one processor is further configured to, in response to a request for notification of the delivery location, send a user an indication of the delivery location based at least in part on the radio frequency fingerprint.

20. The system of claim 13, wherein the at least one processor is further configured:
to receive a plurality of radio frequency fingerprints from a local device; and
to send a notification to the local device indicating that the local device is in a location for a delivery in response to at least one of the plurality of radio frequency fingerprints being substantially similar to a previously stored radio frequency fingerprint associated with a target delivery location for the delivery.
